(19) United States
(12) Patent Application Publication
(10) Pub. No.: US 2026/0331618 A1
(43) Pub. Date: Oct. 22, 2026

(54) BATTERY MODULE CONTAINER PROVIDED WITH A COOLING SYSTEM, ELECTRIC POWER STORAGE SYSTEM, AND ASSOCIATED METHOD

(71) Applicant: SAFT, LEVALLOIS PERRET (FR)

(72) Inventors: Quentin LIEVOUX, LE BOUSCAT (FR); Jennifer CRONIER, MERIGNAC (FR); Stephen AICOBERRY, Saint Loubes (FR); Matthieu BERTIN, VILLENAVE D’ORNON (FR); Arnaud COLLIGNAN, SAINTE EULALIE (FR); Clément THÉTIOT, CARIGNAN DE BORDEAUX (FR)

(73) Assignee: SAFT, LEVALLOIS PERRET (FR)

(21) Appl. No.: 19/108,878

(22) PCT Filed: Sep. 15, 2023
(86) PCT No.: PCT/EP2023/075510

§ 371 Date: Mar. 5, 2025

(30) Foreign Application Priority Data
Sep. 16, 2022 (FR) 22 09342

(51) Int. Cl. H01M 10/613; H01M 10/627; H01M 10/6563; H01M 10/6566; H01M 50/251; H01M 50/367

(52) U.S. Cl. CPC H01M 10/613; H01M 10/627; H01M 10/6563; H01M 10/6566; H01M 50/251; H01M 50/367

(57) ABSTRACT

The invention relates to a container which comprises a system for diffusing cooled air to each battery module, the diffusion system comprising a device for generating cooled air. The cooled air diffusion system comprises at least two horizontal tubes for transporting the cooled air to the battery modules delimiting therebetween an intermediate space, each horizontal tube having a plurality of cooled air diffusion openings intended to open facing successive battery modules placed along the horizontal tubes. The cooled air diffusion system comprises at least one vertical plenum connected to the cooled air generating device and to the horizontal tubes for distributing the cooled air in the horizontal tubes.

### CROSS REFERENCE TO RELATED APPLICATIONS

The present application is a U.S. National Phase Application under 35 U.S.C. § 371 of International Patent Application No. PCT/EP2023/075510 filed Sep. 15, 2023, which claims priority of French Patent Application No. 2209342 filed Sep. 16, 2022. The entire contents of which are hereby incorporated by reference.

### FIELD

The present invention relates to a container of battery modules, including a structure comprising:
a floor with an upper support surface for battery modules,
peripheral walls,
a roof, arranged above the peripheral walls,
the floor, the peripheral walls and the roof defining an internal volume for receiving the battery modules,
a diffusion system for the diffusion of cooled air toward each battery module, comprised in the internal volume, the diffusion system comprising a cooled air generation device.

### BACKGROUND

Such a container is intended to contain battery modules in order to offer a movable source of electrical power, suitable for being installed temporarily or permanently on a site requiring electrical power.

Conventionally, it is known to construct an electrical power storage system by arranging, in a standard parallelepiped container, battery modules and a unit for electrical and thermal management of the modules. Such a storage system can be easily moved, in particular by road, rail, sea or air transport.

The structure of the container receiving the battery modules generally includes a floor, peripheral walls protruding from the floor, and a roof that closes the internal volume containing the battery modules. The peripheral walls are equipped with doors to access the internal volume when is needed.

During operation, the modules included in the container charge to store electrical power received from an electrical power source and discharge to provide electrical power to an electrical power consumer. The successive charges and discharges lead to an overheating of the cells of the battery modules and hence an increase in temperature within the battery modules.

And yet, a battery module should preferentially operate within a very precise temperature range, e.g. between 18 and 25 °C.

In some cases, battery modules can reach a temperature well above the desired temperature, e.g. around 40 °C.

Above a certain temperature, the cells of the battery modules have an irreversibly shortened battery life. In some cases, the degradation leads to events jeopardizing the container, e.g. thermal runaways.

Moreover, below a certain temperature, the modules have an increased internal resistance and heat up more because of the Joule effect.

Therefore, it is necessary to cool the modules so that they are at the ideal temperature for operation.

To this end, it is known to equip the container with a device for generating cooled air by placing it under the roof above the battery modules. The cooled air generation device blows cooled air from top to bottom.

Such a solution is not entirely satisfying. Indeed, the diffusion of cold air from top to bottom around the modules creates a vertical thermal gradient, since the modules at the top are cooler than the modules at the bottom. Similarly, the modules closer to the cooled air generation device are cooled more than those farthest away, which leads to an axial temperature gradient.

To overcome such problem, CN112259827 describes a storage system wherein cold air is transported from top to bottom using ducts towards each battery module connected individually to a duct. The hot air produced in each module is recovered and transported by pipes to a cooled air generation device.

Such a solution is not always optimal. Indeed, since the pipes bringing cold air to the modules are vertical, a vertical thermal gradient always subsists. More particularly, the flow of cold air is not evenly distributed through the different modules, with the upper modules using cold air first, the lower modules continuing to receive warmer air.

In addition, such a solution works notably for use in buildings, where it is possible to easily extract the hot air leaving the modules to the outside and not in applications such as containers, where the volume is restricted and the container must be airtight. Furthermore, the cooling system is bulky.

### SUMMARY

An aim of the invention is to provide an electrical power storage system wherein the overheating of battery modules during successive charges and discharges is limited and takes place homogeneously over all the battery modules.

To this end, the subject matter of the invention is a container of the aforementioned type, characterized in that the cooled air diffusion system comprises at least two horizontal tubes for transporting the cooled air toward the battery modules delimiting therebetween an intermediate space, each horizontal tube having a plurality of openings for diffusing cooled air intended to open opposite successive battery modules placed along the horizontal tubes, the cooled air diffusion system comprising at least one vertical plenum connected to the cooled air generation device and to the horizontal tubes in order to distribute the cooled air in the horizontal tubes.

The container according to the invention can comprise one or a plurality of the following features, taken individually or according to all technically possible combinations:
the cooled air diffusion system comprises at least three horizontal tubes distributed over the height of the vertical plenum, the assembly formed by the horizontal tubes and the vertical plenum forming a cooled air diffusion comb;
the internal volume comprises at least one battery module storage compartment, the horizontal tubes extending horizontally over more than 50% of the length of the battery module storage compartment;
the vertical plenum internally contains a plurality of blades for distributing the cooled air flow between the horizontal tubes;
at least two diffusion openings along each horizontal tube have cross-sections with different surface areas and/or at least one diffusion opening on a first horizontal tube has a cross-section with a different surface area than the surface area of another diffusion opening on another horizontal tube;
at least part of the diffusion openings open vertically upwards, advantageously at least part of the diffusion openings opening vertically downwards;
the plenum has an intake opening for cooled air in its internal space, connected to the cooled air generation device, the inlet opening for cooled air in the internal space having an internal cross-section with a surface area A1 substantially equal to the sum of the surface areas A2 of the internal cross-sections of all horizontal tubes.

A further subject matter of the invention is an electrical power storage system, including:
a container as defined hereinabove;
battery modules received in the internal volume;
terminals, connected to the battery modules and intended to be connected to a consumer of electrical power supplied by the battery modules and/or to an electrical power supplier for recharging the battery modules.

The system according to the invention can comprise one or a plurality of the following features, taken individually or according to all technically possible combinations:
the storage system comprises at least one row of battery modules, each row comprising a plurality of columns of battery modules, the horizontal tubes extending along the row of battery modules at different heights opposite each column;
each battery module is placed opposite a horizontal tube, the horizontal tube comprising a diffusion opening specific to each battery module;
each battery module comprises an outer housing defining a fresh air intake passage, the diffusion opening coming out in the vicinity of the fresh air intake passage without any connection to the fresh air intake passage;
the outer housing has a hot air exhaust passage, the hot air exhaust passage coming out into the internal volume without being connected to a hot air collection system;
the cooled air generation device comprises a hot air intake inlet, the battery modules and the cooled air diffusion system delimiting externally in the internal volume a fluidic path between each hot air exhaust passage and the intake inlet.

A further subject matter of the invention is a cooling method for battery modules in a storage system as defined hereinabove, the method comprising the following steps:
generation of cooled air using the cooled air generation device,
passage of cooled air in the vertical plenum to distribute it between the horizontal tubes,
circulation of cooled air through the horizontal tubes to the diffusion openings,
diffusion of cooled air from the diffusion openings to the battery modules,
intake of cooled air into the battery modules.

The method according to the invention can comprise one or a plurality of the following features, taken individually or according to all technically possible combinations:
the difference of temperature between the temperature of the hottest battery module and the average temperature of the battery modules is less than 5 °C;
the cooling method comprises a discharge of heated air by each battery module, and a circulation of the heated air between the battery modules and the cooled air diffusion system toward an intake inlet of heated air of the cooled air generation device, without passing through a hot air collection system.

### BRIEF DESCRIPTION OF THE DRAWINGS

Further features and advantages of the invention will become more apparent from the description, which is illustrated by way of non-limiting example in the drawings, which:

FIG. 1 is a three-quarter front perspective view of a first electrical power storage system according to the invention;

FIG. 2 is a section view along a median vertical plane, of the first electrical power storage system according to the invention;

FIG. 3 is a section view along a horizontal plane, of the first electrical power storage system according to the invention;

FIG. 4 is a schematic section view along a vertical plane, of a plenum of the cooled air diffusion system of the first electrical power storage system according to the invention; and

FIG. 5 is a view similar to FIG. 3 showing a variant of an electrical power storage system according to the invention.

### DETAILED DESCRIPTION

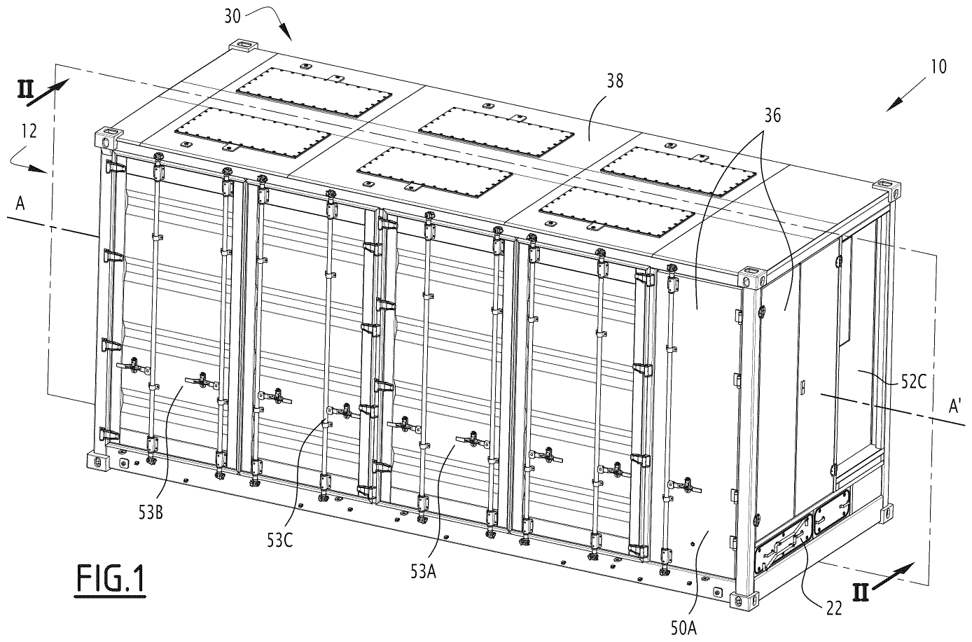

FIGS. 1 to 4 illustrate a first electrical energy storage system 10 according to the invention.

The storage system 10 is intended to be moved to an operation site, e.g. by a road vehicle such as a truck, by a railway vehicle, and/or by a sea vehicle such as a transport ship. It is intended to be electrically connected to a network for the use of electrical energy at an operation site and alternately to a network for the supply of electrical energy to be recharged.

The storage system 10 includes a container 12 for battery modules, delimiting an internal volume 14, and a plurality of battery modules 16 received in the internal volume 14. The storage system 10 advantageously includes a battery management module (BMM) 16 for the electrical and thermal management of the modules and a security system (not shown).

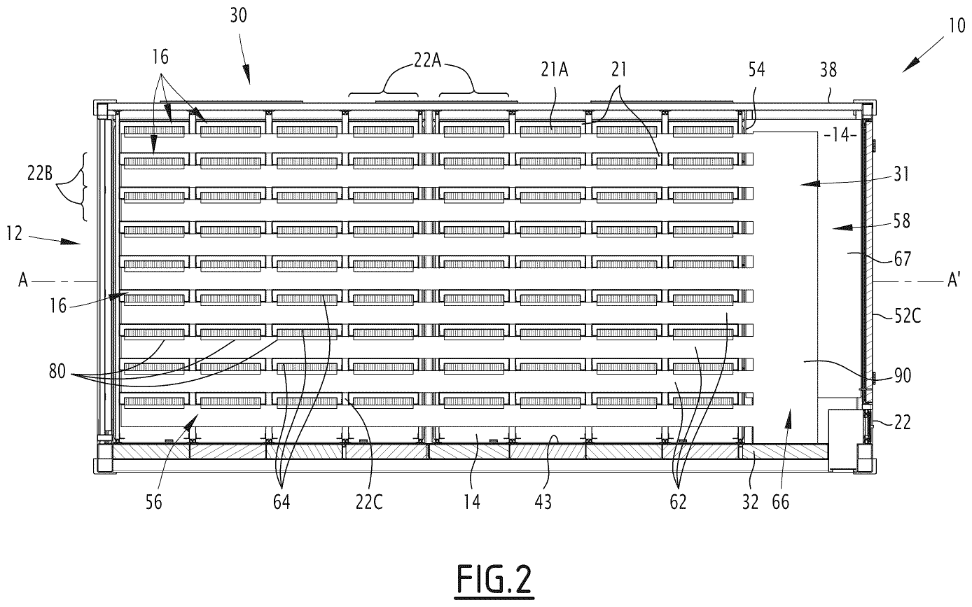

In the present example, with reference to FIG. 2, the container 12 contains e.g. between 10 and 150 battery modules 16. It extends along a longitudinal axis A-A′.

The battery modules 16 are mounted in series and/or in parallel in order to deliver electrical power which can reach e.g. up to 4 MWh for voltages ranging in particular up to 1500 V to at least two electrical terminals 22 present on the container 12.

Each battery module 16 includes a plurality of electrochemical cells, e.g. received in prismatic or cylindrical inner housings or in flexible pockets. Each electrochemical cell includes anodes, cathodes and separators, between which electrochemical reactions take place.

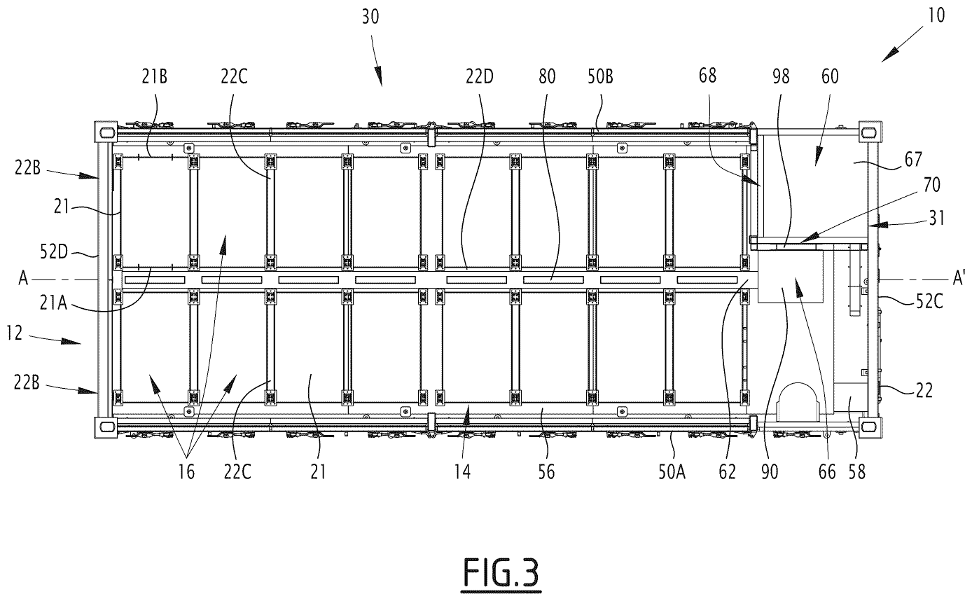

Each battery module 16 comprises an outer casing 21 containing the inner casings or the cell pockets. As can be seen in FIGS. 2 and 3, each outer casing 21 comprises a fresh air intake passage 21A opening here toward the axis A-A′ and a hot air exhaust passage 21B opening here away from the axis A-A′.

The battery modules 16 are arranged vertically in the form of columns 22A and horizontally in the form of at least one row 22B, here at least two parallel rows 22B extending parallel to the longitudinal axis A-A′ of the container 12.

Each row 22B comprises a plurality of columns 22A of battery modules 16, arranged one after the other parallel to the axis A-A′.

The columns 22A define therebetween transverse intermediate volumes 22C. Similarly, the rows 22B delimit therebetween an axial intermediate volume 22D, the volumes 22C, 22D allowing a flow of air to circulate.

The management system (not shown) is suitable for controlling the voltage and current delivered by each battery module when supplying electrical power, and the power and current delivered to each battery module when recharging the battery modules 16.

The electrical terminals 22 are intended to be connected to the user network (not shown) for supplying electrical energy stored in the battery modules 16, and alternately to an electrical power supply network for recharging the battery modules 16.

The safety system (not shown) includes e.g. sensors for the detection of temperature and/or pressure in the internal volume 14, a source of inert gas, and a control unit apt to deliver the inert gas into the internal volume 14 from the source of inert gas, upon detection of an increase in temperature, smoke, carbon monoxide and/or pressure greater than a given threshold in the internal volume 14.

With reference to FIG. 1, the container 12 comprises a self-supporting structure 30, intended to define the internal volume 14, and to make possible the joint transport of the battery modules 16, the management system, and the security system to an operation site. It contains, as can be seen in FIGS. 2 and 3, a system 31 for diffusing cooled air toward each battery module 16 contained in the internal volume 14.

With reference to FIGS. 1 and 2, the structure 30 includes a floor 32, peripheral walls 36 protruding from the periphery of the floor 32 and a roof 38. The floor 32, the peripheral walls 36 and the roof 38 internally delimit the internal volume 14.

The structure 30 of the container 12 has here a polyhedral shape. More particularly, the structure 30 has the shape of a rectangular parallelepiped, extending longitudinally along the longitudinal axis A-A′ which is horizontal when the container 12 is placed on a horizontal support.

The dimensions of the structure 30 are governed by the transport standards.

The container 12 has e.g. a length greater than 2 m, in particular comprised between 2.5 m and 15 m, a width greater than 1 m, in particular comprised between 2 m and 4 m, and a height greater than 1 m, in particular comprised between 2 m and 4 m.

The container 12 is in particular a so-called “High Cube” 20-foot container with a length of 6.058 m, a width of 2.438 m and a height of 2.896 m. However, the present invention applies to any type of container having ISO corners (e.g. 40 feet (12 m), 10 feet (3 m), etc.).

Here, the floor 32 is flat. With reference to FIG. 2, it defines upwards a flat upper support surface 43 which supports the battery modules 16, the cooled air diffusion system 31, the management system as well as the safety system when the safety system is present.

With reference to FIGS. 1 to 3, the peripheral walls 36 include two longitudinal vertical walls 50A, 50B, the longitudinal walls 50A, 50B being arranged vertically, parallel to the axis A-A′, on either side of the axis A-A′.

The peripheral walls 36 further include two transverse vertical walls 52C, 52D extending perpendicularly to the axis A-A′ and connecting the longitudinal walls 50A, 50B to each other at the longitudinal ends of the structure 30.

The longitudinal walls 50A, 50B and the transverse walls 52C, 52D delimit, in pairs, corners of the structure 30. They delimit the internal volume 14 toward the outside.

As can be seen in FIGS. 1 to 3, the longitudinal walls 50A, 50B and, if appropriate, the transverse walls 52C, 52D are provided with movable doors 53A, 53B making it possible to provide a passage for access to the internal volume 14 from outside the container 12, and with a mechanism 53C for locking the movable doors 53A, 53B.

Advantageously, with reference to FIG. 2, the structure 30 may include an internal partition 54 with the internal volume 14, delimiting in the internal volume 14 a compartment 56 for storing battery modules 16, and separately a control compartment 58, receiving the management system and the security system.

The cooled air diffusion system 31 is arranged in an internal volume 14. It comprises a device 60 for generating cooled air (visible in FIG. 3), and horizontal tubes 62 for the diffusion cooled air toward the battery modules 16, delimiting, in pairs, intermediate spaces 64. The cooled air diffusion system 31 further comprises a vertical plenum 66 for distributing in the horizontal tubes 62 the cooled air produced by the generation device 60, interposed between the generation device 60 and the horizontal tubes 62.

With reference to FIG. 3, the cooled air generation device 60 comprises e.g. an air conditioning apparatus 67 accepting hot air at a hot air intake inlet 68 and delivering cooled air to a cooled air discharge outlet 70.

The horizontal tubes 62 extend linearly in an intermediate volume 22C along a row 22B of battery modules 16. Here, all horizontal tubes advantageously extend parallel to the longitudinal axis A-A′.

The horizontal tubes 62 extend over at least part of the length of the facing rows 22B, herein over the entire length of the rows 22B.

Each horizontal tube 62 is placed opposite the successive faces of the outer housings 21 of the battery modules 16 wherein the fresh air intake passages 21A are formed, at a predefined height relative to the floor 32. Advantageously, each horizontal tube 62 is placed in the vicinity of or in contact with the successive faces of the outer housings 21 of the battery modules 16 wherein the fresh air intake passages 21A are formed.

Each fresh air intake passage 21A of a battery module 16 present in a column 22A within a row 22B is thereby advantageously arranged opposite a horizontal tube 62.

The horizontal tubes 62 are disjoint and are placed at different heights. They are separated in pairs by the intermediate spaces 64. The height of each intermediate space 64 between two adjacent horizontal tubes 62 is preferably greater than 10% of the height separating the central axes of the two adjacent horizontal tubes 62.

The height of each space 64 is preferably equal to the height of a module 16 so that the horizontal tubes 62 are exactly opposite to the fresh air intake passages 21A.

The horizontal tubes 62 preferably have coplanar central axes situated in the same vertical plane containing the longitudinal axis A-A′ or parallel to the longitudinal axis A-A′.

The horizontal tubes 62 have a vertical section, taken perpendicularly to their central axis, of polygonal or circular outer contour.

Furthermore, each horizontal tube 62 has, along its length, a plurality of openings 80 for the diffusion of cooled air, opening upwards. Advantageously, certain horizontal tubes 62, e.g. the uppermost tube, also have openings 80 for the diffusion of cooled air, opening downwards.

In certain cases, the tubes 62 may have openings 80 for the diffusion of cooled air, at the top and at the bottom, facing each other.

The air diffusion openings 80 advantageously have cross-sections of different surface areas along each horizontal tube 62 and between the horizontal tubes 62, in order to distribute the air between the battery modules 16 depending on their need of cooling.

Thereby, preferably, at least two air diffusion openings 80 along each horizontal tube 62 have cross-sections of different surface areas and/or at least one air diffusion opening 80 on a horizontal tube 62 has a cross-section with a different surface area from another air diffusion opening 80 on another horizontal tube 62.

Advantageously, at least one air diffusion opening 80 is placed opposite each fresh air intake passage 21A of each battery module 16 to make possible the diffusion of cooled air from a horizontal tube 62 to each battery module 16 via the fresh air intake passage 21A.

As can be seen in the figures, the cooled air diffusion system 31 has no duct connecting the air diffusion openings 80 to the fresh air intake passages 21A. Thereby, the cooled air passes freely and without physical hindrance between the air diffusion openings 80 and the fresh air intake passages 21A in the intermediate space 64 between two adjacent horizontal tubes 62.

The vertical plenum 66 is intended to receive the flow of cooled air coming from the cooled air generation device 60 and to distribute the flow of cooled air between the different horizontal tubes 62 according to the individual cooling needs of the battery modules 60 situated opposite each horizontal tube 62.

The vertical plenum 66 extends at least over the entire height of the horizontal tubes 62, at one longitudinal end of the horizontal tubes 62.

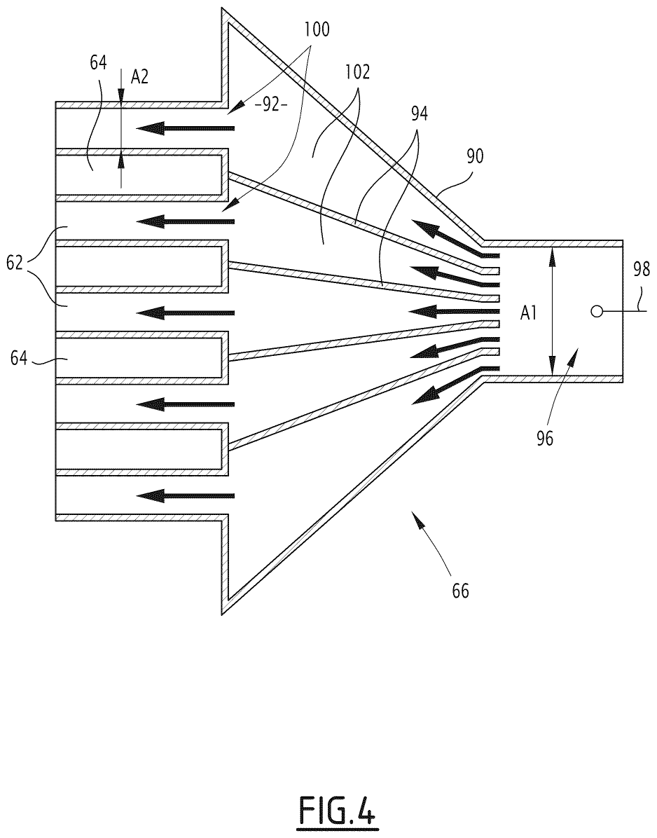

With reference to FIG. 4, which is a schematic representation, the vertical plenum 66 comprises a casing 90 defining an internal space 92, and blades 94 for distributing cooled air in each horizontal tube 62, arranged in the internal space 92.

The casing 90 has an opening 96 for the intake of cooled air into the internal space 92 connected to the cooled air outlet 70 of the cooled air generation device 60 via a distribution duct 98 which may be bent.

The casing 90 defines, opposite the horizontal tubes 62, a plurality of vertically distributed cooled air distribution openings 100 to which the horizontal tubes 62 are connected. Each distribution opening 100 thereby feeds exclusively a respective horizontal tube 62.

The vertical plenum 66 and the horizontal tubes 62 assembled on the vertical plenum 66 together form a comb for distributing the cooled air to the different battery modules 16.

With reference to FIG. 4, the cooled air intake opening 96 in the internal space 92 has a maximum internal vertical section with a surface area A1 (taken perpendicularly to the local axis of the opening 96) greater than at least twice the surface area A2 of the maximum vertical internal section of each horizontal tube 62 (taken perpendicularly to the central axis of the horizontal tube 62). The surface area A1 is also substantially equal to the sum of the surface areas A2 of the internal sections of all the horizontal tubes 62, e.g. between 80% and 120% of the sum of the surface areas A2.

The air distribution blades 94 are arranged horizontally and/or inclined in the internal space 92 to create disjoint channels 102 for supplying cooled air connected upstream to the intake opening 96 and downstream, each, to a respective distribution opening 100.

Each channel 102 thereby has an internal cross-section which advantageously increases from the intake opening 96 to each distribution opening 100. In a variant, depending on the need in terms of pressure and flow-rate, the internal cross-section is constant or decreasing.

The air circulating in the channels 102 is thereby suitable for being distributed in the different horizontal tubes 62 depending upon the predetermined need for cooled air of each horizontal tube 62, which is as such dependent on the predetermined individual need for cooled air of each battery module 60 situated along the horizontal tube 62.

In the example shown in the figures, the battery modules 16 and the cooled air diffusion system 31 externally delimit in the internal volume 14 a free fluidic path between each hot air discharge passage 21B and the hot air intake inlet 68 of the cooled air generation device 60. Said path extends here, in the transverse intermediate volumes 22C, and/or in the axial intermediate volumes 22D between the outer housings 21 of the battery modules 16 and the peripheral walls 36 of the container 12.

The container 12 is thereby devoid of a hot air collection system comprising clean ducts for guiding the hot air. Thereof significantly improves the volume available in the container 12 for arranging battery modules 16 therein.

In operation, the container 12 is connected to a user network for delivering electrical power to the network from the battery modules 16 present in the container 12 or to a source of electrical power in order to recharge the battery modules 16 present in the container 12.

To compensate for possible overheating within the battery modules 16, cooled air is continuously produced by the cooled air generation device 60. The cooled air has a temperature lower than the ambient temperature within the internal volume 14, e.g. 10 °C lower than the ambient temperature.

The cooled air flow thereby generated is conveyed to the vertical plenum 66 via the distribution duct 98 and the opening 96 for the intake of cooled air. It is distributed in the horizontal tubes 62 by means of the circulation channels 102 created by the distribution blades 94.

The cooled air then circulates in the horizontal tubes 62 via the distribution openings 100 and leaves each horizontal tube 62 via diffusion openings 80 facing the battery modules 16.

The cooled air then moves toward the fresh air intake passages 21A of the outer housings 21 of the different battery modules 16 to cool each battery module 16.

The heated air in each battery module 16 then exits via the hot air discharge passage 21B of the outer casing 21 of the battery module 16 and comes out into the internal volume 14. It travels freely in the internal volume 14 toward the hot air intake inlet 68 of the cooled air generation device 60.

The cooled air diffusion system 31 of the container 12 according to the invention thus cools all the battery modules 16 homogeneously by distributing the cooled air in a way suitable for the thermal configuration of the battery modules 16. It is thus possible to cool all battery modules 16 more efficiently with the same air conditioning capacity, and thus to increase the service life of the energy storage system 10.

Due to the arrangement of a plenum 66 and of horizontal tubes 62 protruding from the plenum 66, the temperature difference between the temperature of the hottest battery module 16 and the average temperature of the battery modules 16 is advantageously less than 5 °C.

Furthermore, the horizontal arrangement of the tubes 62 and the presence of intermediate spaces 64 between them ensures maximum compactness of the cooled air diffusion system 31, while permitting the passage of beams and structural uprights of the container and/or racks of supports of the battery modules 16 into the intermediate spaces 64.

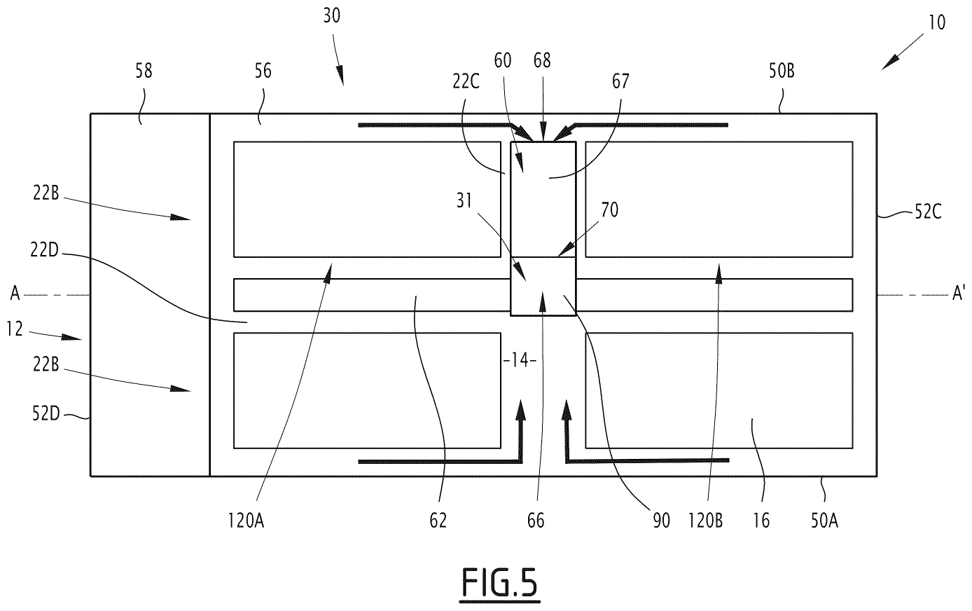

In a variant, shown diagrammatically in FIG. 5, the cooled air generation device 60 is arranged in a central region of the internal volume 14 within a transverse intermediate volume 22C between two longitudinal segments 120A, 120B of a row 22B of battery modules 16.

The vertical plenum 66 is also positioned in the central region, facing the cooled air generation device 60. The horizontal tubes 62 then protrude longitudinally on either side of the central plenum 66 to extend respectively opposite each segment 120A, 120B of the row of battery modules 60.

1. A container including a structure comprising:
a floor having an upper support surface configured to support battery modules,
peripheral walls,
a roof, arranged above the peripheral walls,
the floor, the peripheral walls and the roof defining an internal volume for receiving the battery modules,
a cooled air diffuser configured to diffuse a cooled air toward each battery module, comprised in the internal volume, the cooled air diffuser, comprising a cooled air generator,
the cooled air diffuser comprising at least two horizontal configured to transport the cooled air toward the battery modules, the at least two horizontal tubes delimiting therebetween an intermediate space, each horizontal tube having a plurality of diffusion openings configured to defuse cooled air, the plurality of diffusion openings being configured to open opposite successive battery modules placed along the horizontal tubes, the cooled air diffusion system comprising at least one vertical plenum connected to the cooled air generator and to at least two horizontal tubes to distribute the cooled air in at least two horizontal tubes.

2. The container according to claim 1, wherein the at least two horizontal tubes comprise at least three horizontal tubes distributed over the height of the vertical plenum, the at least three horizontal tubes and at least one vertical plenum together forming a cooled air diffusion comb.

3. The container according to claim 1, wherein the internal volume comprises at least one battery modules storing compartment, the at least two horizontal tubes extending horizontally over more than 50% of a length of the battery modules storing compartment.

4. The container according to claim 1, wherein the at least one vertical plenum internally contains a plurality of blades configured to distribute the cooled air flow between the at least two horizontal tubes.

5. The container according to claim 1, wherein the plurality of diffusion openings comprise at least two diffusion openings along each horizontal tube having cross-sections with different surface areas and/or wherein the plurality of diffusion openings comprise at least one first diffusion opening on one horizontal tube of the at least two horizontal tubes and at least a second diffusion opening on another horizontal tube of the at least two horizontal tubes, the at least one first diffusion opening having a cross-section with a different surface area than a surface area of the at least one second diffusion opening.

6. The container according to claim 1, wherein at least a portion of the plurality of openings open vertically upwards.

7. The container according to claim 1, wherein the at least one vertical plenum defines an internal space and has a cooled air inlet opening in the internal space, the cooled air inlet opening being connected to the cooled air generator, the cooled air inlet opening in the internal space having an inner cross-section with a surface area substantially equal to the sum of the surface areas of inner cross-sections of all the horizontal tubes of the at least two horizontal tubes.

8. An electrical power storage system including:
a container according to claim 1;
battery modules received in the internal volume;
terminals, connected to the battery modules and configured to be connected to a consumer of electrical power supplied by the battery modules and/or to an electrical power supplier to recharge the battery modules.

9. The storage system according to claim 8, comprising at least one row of battery modules, and a plurality of columns of battery modules, the horizontal tubes extending along the at least one row of modules at different heights opposite each column of the plurality of columns.

10. The storage system according to claim 8, wherein each battery module is positioned opposite a given horizontal tube of the at least two horizontal tubes, the give horizontal tube comprising at least one diffusion opening of the plurality of diffusion openings being in correspondence with each battery module.

11. The storage system according to claim 8, wherein each battery module includes an outer housing defining a fresh air intake passage, at least one give diffusion opening adjacent to the fresh air intake passage without any connection to the fresh air intake passage.

12. The storage system according to claim 8, wherein the outer housing has a hot air exhaust passage, the hot air exhaust passage merging into the internal volume without being connected to a hot air collection system.

13. The storage system of claim 12, wherein the cooled air generator comprises a hot air intake inlet, the battery modules and the cooled air diffuser externally defining, in the internal volume, a fluidic path between each hot air exhaust passage and the hot air intake inlet.

14. A method of cooling battery modules of a storage system according to claim 1, the method comprising:
generating a cooled air using the cooled generator,
passing the cooled air in the at least one vertical plenum to distribute the cooled air between the at least two horizontal tubes,
circulating cooled air through the at least two horizontal tubes to the diffusion openings,
diffusing the cooled air from the plurality of diffusion openings to the battery modules,
intaking the cooled air into the battery modules.

15. The cooling method according to claim 14, comprising discharging a heated air from each battery module, and circulating the heated air between the battery modules and the cooled air diffuser to a heated air intake inlet of the cooled air generator, without passing through a hot air collection system.

16. The container according to claim 6, wherein at least another portion of the plurality of diffusion openings open vertically downwards.
